(19) United States
(12) Patent Application Publication
(10) Pub. No.: US 2014/0035516 A1
(43) Pub. Date: Feb. 6, 2014

(54) TELEVISION LOW POWER MODE AND ACCESSORY CHARGING

(71) Applicants: Roger A. Fratti, Mohnton, PA (US); Aaron J. Young, Louisville, CO (US); William R. Thomas, Bethlehem, PA (US)

(72) Inventors: Roger A. Fratti, Mohnton, PA (US); Aaron J. Young, Louisville, CO (US); William R. Thomas, Bethlehem, PA (US)

(73) Assignee: LSI Corporation

(21) Appl. No.: 13/562,473

(22) Filed: Jul. 31, 2012

(51) Int. Cl. H02J 7/00

(52) U.S. Cl. 320/108

(57) ABSTRACT

Described embodiments provide a local electronic device having a power supply coupled to a power main in wireless communication, via a wireless transceiver, to a remote device. The local electronic device includes a charging station to recharge a rechargeable power supply of the remote devices. The local electronic device detects when at least one remote device is being recharged by the charging station. Based on the detection, the local electronic device selectively enters a low-power mode by disabling one or more circuits to reduce power consumption.

### BACKGROUND

Battery-powered remote control devices are often used for operating electronic devices. For example, typical home theater equipment such as televisions, stereo receivers, video game consoles, cable and satellite receivers, video recorders, compact and video disc players, and other equipment, often have a remote control for using and controlling the equipment. Other battery powered peripheral devices, such as game controllers or three-dimensional (3D) viewing glasses might also be used. Remote control units typically transmit wireless signals to the devices they control, for example by infrared or radio frequency signals. Remote control units typically are also powered by one or more removable batteries. Often, remote control units have a battery compartment where non-rechargeable batteries might be replaced as they wear down with use and/or age.

More recently, mobile devices, and some remote control units, employ rechargeable batteries that might be charged by plugging the device into a charger (such as shown in U.S. Patent Application Publication 2012/0069294 to Ohno et al.), plugging the device into a charging station (such as shown in U.S. Design Pat. No. D501,200 to Tsai et al.), resting the device on an inductive charging pad (such as shown in U.S. Pat. No. 7,906,936 to Azancot et al.), or plugging the device directly into a wall socket (such as shown in U.S. Pat. No. 6,489,746 to Pettinato). Some proposed charging systems describe placing the remote control unit in a charging station located on the equipment for which the remote control is used (for example a television having a charging station as shown in U.S. Patent Application Publication 2006/0055372 to Jackson, and a television having corded or wireless chargers as shown in U.S. Patent Application Publication 2011/0255160 to Lee et al.).

Further, typical home theater equipment might continue to power various circuits within the equipment itself, even if the equipment is not in use or is otherwise “turned off”. For example, a typical high-definition television might draw power in “standby mode” when the screen is off in order to respond quickly to remote control commands to turn on. Similarly, a typical video game console might continually draw power even when switched “off” or in “standby mode”. Thus, an improved system for recharging remote controls and reducing power consumption of electronic devices is needed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments provide a local electronic device having a power supply coupled to a power main in wireless communication, via a wireless transceiver, to a remote device. The local electronic device includes a charging station to recharge a rechargeable power supply of the remote devices. The local electronic device detects when at least one remote device is being recharged by the charging station. Based on the detection, the local electronic device selectively enters a low-power mode by disabling one or more circuits to reduce power consumption.

### BRIEF DESCRIPTION OF THE DRAWING FIGURES

Other aspects, features, and advantages of the present invention will become more fully apparent from the following detailed description, the appended claims, and the accompanying drawings in which like reference numerals identify similar or identical elements.

FIG. 1 shows an exemplary block diagram of an electronics system in accordance with exemplary embodiments;

FIG. 2 shows an exemplary block diagram of circuit elements of a television of the system of FIG. 1 in accordance with exemplary embodiments;

FIG. 3 shows an exemplary block diagram of circuit elements of a remote control device of the system of FIG. 1 in accordance with exemplary embodiments;

FIG. 4 shows an exemplary diagram of a remote charging station of the system of FIG. 1 in accordance with exemplary embodiments;

FIG. 5 shows another exemplary diagram of a remote charging station of the system of FIG. 1 in accordance with exemplary embodiments;

FIG. 6 shows another exemplary diagram of a remote charging station of the system of FIG. 1 in accordance with exemplary embodiments;

FIG. 7 shows an exemplary block diagram of circuit elements of the peripheral device charger of FIG. 2 in accordance with exemplary embodiments;

FIG. 8 shows an exemplary block diagram of circuit elements of the remote charging station of FIG. 6;

FIG. 9 shows an exemplary flow diagram of a recharging process of the system of FIG. 1 in accordance with exemplary embodiments;

FIG. 10 shows additional detail of a low-power mode entry process of the recharging process of FIG. 9 in accordance with exemplary embodiments;

FIG. 11 shows additional detail of a recharging step of the recharging process of FIG. 9 in accordance with exemplary embodiments; and

FIG. 12 shows additional detail of a low-power mode exit process of the recharging process of FIG. 9 in accordance with exemplary embodiments.

### DETAILED DESCRIPTION

Described embodiments provide a local electronic device having a power supply coupled to a power main in wireless communication, via a wireless transceiver, to a remote peripheral device. The local electronic device includes a charging station to recharge a rechargeable power supply of the remote peripheral devices. The local electronic device detects when at least one remote peripheral device is being recharged by the charging station. Based on the detection, the local electronic device selectively enters a low-power mode by disabling one or more circuits to reduce power consumption.

Table 1 defines a list of acronyms employed throughout this specification as an aid to understanding the described embodiments of the present invention:

TABLE 1

| | | | |
|---|---|---|---|
| USB | Universal Serial Bus | DVD | Digital Versatile Disc or |
| | | | Digital Video Disc |
| HD | High Definition | TV | Television |
| DVR | Digital Video Recorder | AC | Alternating Current |
| DC | Direct Current | VGA | Video Graphics Array |
| DVI | Digital Visual Interface | HDMI | High Definition |
| | | | Multimedia Interface |
| A/V | Audio/Video | LCD | Liquid Crystal Display |
| CRT | Cathode-Ray Tube | SoC | System-on-Chip |
| 3D | Three Dimensional | i | interlaced |
| p | Progressive scan | IR | infrared |
| LED | Light Emitting Diode | IC | Integrated Circuit |
| ATSC | Advanced Television | DVB | Digital Video Broadcasting |
| | Systems Committee | | |
| RF | Radio Frequency | fps | frames per second |

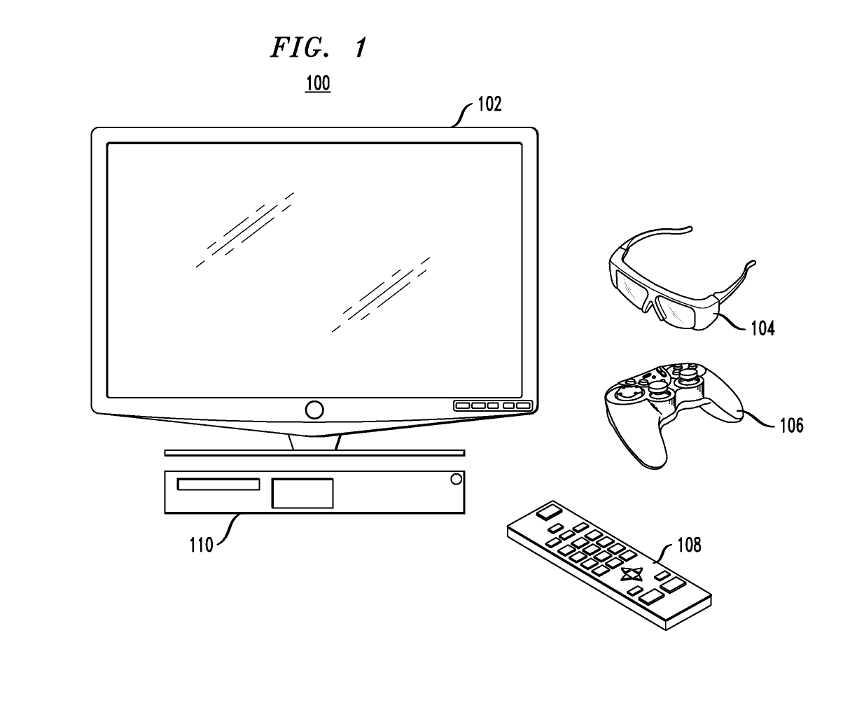

FIG. 1 shows a block diagram of an exemplary home theater system 100 that includes television (TV) 102, which might typically be a high-definition (HD) TV that, for example, might display HD video in 720i/p or 1080i/p at 24 frames per second (fps) or higher, in accordance with Advanced Television Systems Committee (ATSC) standards in the United States, or the Digital Video Broadcasting (DVB) standards internationally. TV 102 might also display three-dimensional (3D) video in accordance with, for example, DVB standards. Viewing of 3D video might, depending on the type of 3D display technology, require viewers of TV 102 to employ 3D glasses 104. 3D glasses 104 might frequently employ active components that require a power source that might typically include one or more batteries. Home theater system 100 might also include one or more additional components, shown generally as 110, that might include, but is not limited to, a digital video disc (DVD) or video disc player, a cable or satellite receiver, a digital video recorder (DVR), a video game console, a stereo receiver, or other home theater components.

Each of components 110 and TV 102 might be remote controlled, either with corresponding specific remote control devices, or together with a single universal remote control, shown generally as remote control 108. Each of components 110 might further be operated with one or more keypads, joysticks and game or other controllers, shown generally as controller 106. Remote controls 108 and controllers 106 might typically communicate wirelessly with their corresponding master devices 102 and 110, for example, via infrared (IR) signals or radio frequency (RF) signals. For example, in some embodiments, wireless communication might be performed in any corresponding radio bands from 5 MHz to 140 GHz (above 140 GHz might be considered optical range). Thus, remote controls 108 and controllers 106 might also typically include one or more batteries to provide power to the wireless transmitters and various other active components (e.g., indicator lights, etc.). Each master device 102 and 110 might typically be powered from the electrical mains of the building in which theater system 100 is located (e.g., 120V or 230V AC), either directly by a cord or through a plug-in power adapter (not shown). Even in the “off” state, various of TV 102 and devices 110 might still consume power from the mains to power various circuit components.

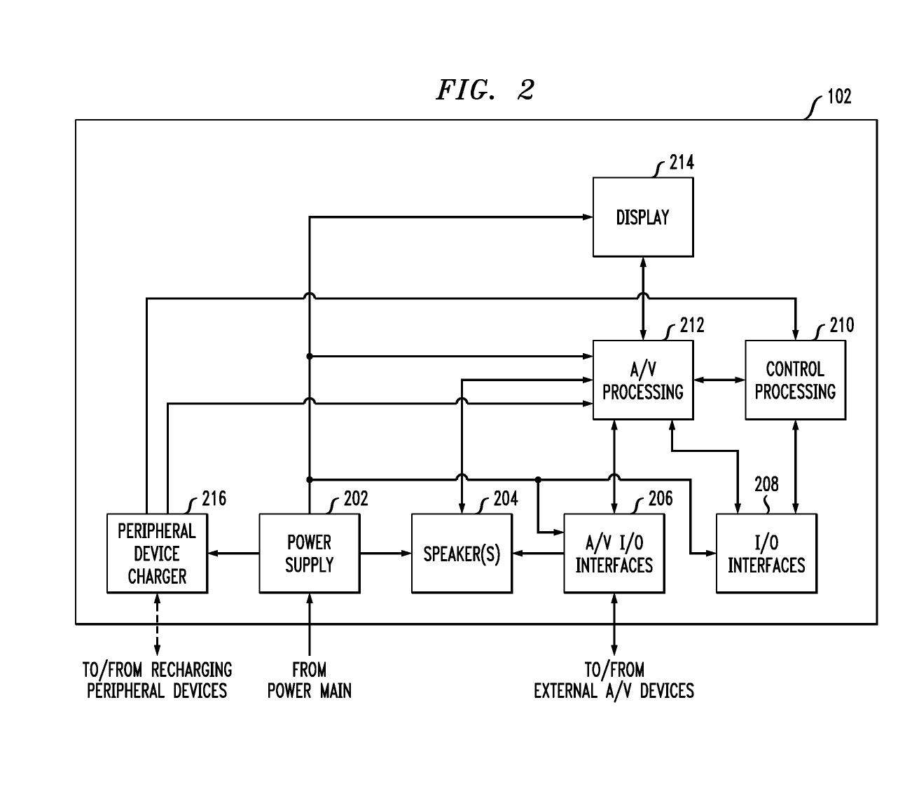

FIG. 2 shows an exemplary block diagram of circuit elements of TV 102. As shown in FIG. 2, TV 102 receives electrical power from the electrical mains. Power supply 202 generates one or more DC voltages from the mains power. Power supply 202 might typically supply the one or more DC voltages for operation of various circuit elements of TV 102, as shown. For example, typical voltages include 1.2V, 1.5V, 2.5V, 3.3V, 5V, 12V, 24V etc., relative to a ground or circuit common TV 102 receives one or more input signals, and provides various output signals, for example audio and video (A/V) signals, to and from various of devices 110. For example, TV 102 might receive A/V signals from a cable or satellite receiver via one or more cables, such as a coaxial cable, one or more video component cables, a DVI cable, a VGA cable, an optical cable, an HDMI cable, or any other suitable interconnection. I/O interfaces 208 might include one or more interfaces to receive input from external sources. For example, TV 102 might include one or more physical buttons to receive user input, and might typically include an IR receiver and/or RF receiver to receive commands from remote controls 108. The IR receiver might be implemented as the TSMP4138 manufactured by Vishay Semiconductors of Malvern, Penn., or any other suitable IR receiver. The RF receiver might be implemented as an IEEE 802.15 (e.g., “Bluetootht”) transceiver such as the LMX9830 by Texas Instruments/National Semiconductor of Dallas, Tex., or any other suitable RF receiver. Additionally, TV 102 might include an Ethernet port, WiFi transceiver, USB port, IEEE 1394 (“Firewire”) port, or other interface connected to a network or used to receive commands from remote controls or to receive data from sources such as a camera, a computer, a media server or the Internet.

TV 102 might typically include various processors, shown generally as A/V processing module 212 and control processing module 210. A/V processing module 212 might typically decode A/V data received via interface 206 for output as audio via speakers 204 and video via display 214. For example, A/V processing module 212 might be implemented as an FLI7540 system-on-chip (SoC) manufactured by ST Microelectronics of Geneva, Switzerland, or any other suitable A/V processor. Although shown as a separate module, A/V processing module 212 might include the functionality of one or more of A/V interface 206, I/O interface 208 and control processing module 210. A/V processing module 212 might also include a tuner for selecting one or more channels for viewing, although tuning functionality might be implemented by a separate tuner (not shown). A/V processing module 212 might include control circuitry for display 214 (e.g., to control the LCD display and LED backlighting), or the display-specific control might be implemented by a separate display controller (not shown). Data from I/O interfaces 208 might typically be provided to one or both of A/V processing module 212 and control processing module 210 depending on the type of data received. TV 102 includes display 214 for providing video output. For example, display 214 might be implemented using a cathode-ray tube (CRT) screen, a rear projection screen, flat panel plasma screen, flat panel liquid crystal display (LCD) screen, Organic Light Emitting Diode (OLED) screen, LED projector, Lamp Projector or any other similar display technology.

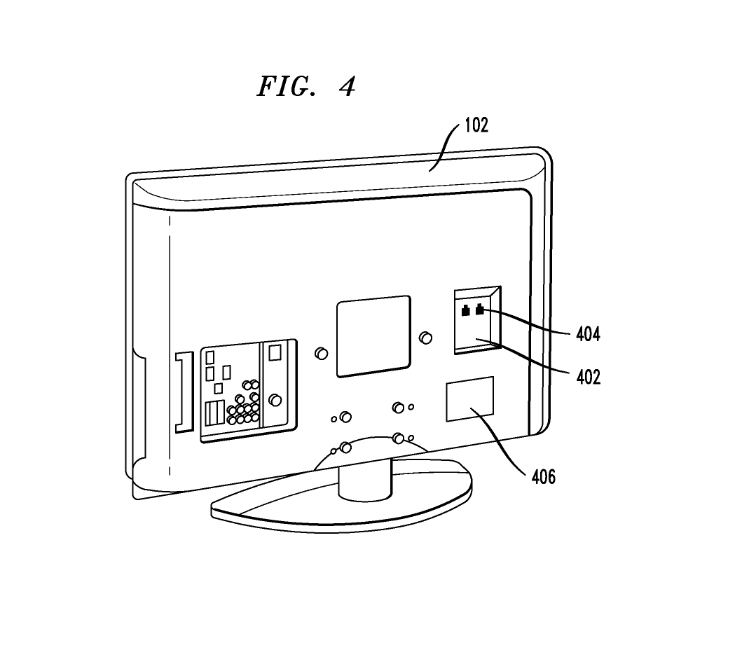

In described embodiments, TV 102 includes peripheral device charger 216. Peripheral device charger 216 provides recharging capability to one or more peripheral devices of TV 102 (or, more generally, home theater system 100), such as remote controls 108, game controllers 106, 3D glasses 104 and any other devices, such as keyboards, mice, etc. Peripheral device charger 216 is also in communication with AN processing module 212 and control processing module 210 to enter a low-power operating mode when corresponding peripheral devices are being recharged and, thus, are not in use. As will be described herein, peripheral device charger 216 might recharge one or more peripheral devices 104, 106 and 108 via one or more sets of physical contacts, one or more inductive chargers or one or more charging cords. Peripheral device charger 216 is described in greater detail in regard to FIGS. 4-8.

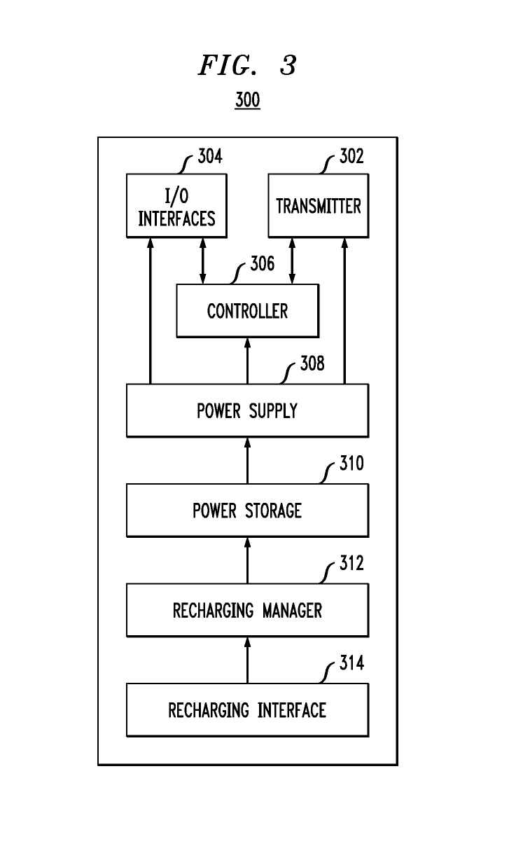

FIG. 3 shows an exemplary block diagram of a generic remote control device 300. As shown, in described embodiments, remote control device 300 includes recharging interface 312 to receive power from peripheral device charger 216. For example, recharging interface 312 might be implemented as a contact pair to receive power from contacts of peripheral device charger 216, or might be implemented as a coil to inductively receive power from an inductive charger of peripheral device charger 216. Recharging interface might also be implemented as a physical port to receive a charging cord of peripheral device charger 216. Received power might be provided to recharging manager 312, which controls the recharging of power storage device 310. For example, recharging manager 312 might be implemented as charge controller chip such as the STBC08 manufactured by ST Microelectronics of Geneva, Switzerland, or any other suitable power manager.

Recharging manager 312 provides controlled recharging (e.g., constant current and constant voltage, temperature monitoring, etc.) to power storage device 310. In some embodiments, power storage device 310 might be implemented as one or more batteries such as, but not limited to, Lithium-Ion (Li-ion) batteries, Nickel-metal hydride (NiMH) batteries, nickel-cadmium (Ni—Cd) batteries, and other similar rechargeable battery technologies. In other embodiments, power storage device 310 might be implemented as a “supercapacitor” (or “ultracapacitor”). For example, a typical IR transmission pulse might generally consume about 100 mW per second at 3.3V. Typical transmissions might occur in bursts lasting about 100 ms. Thus, a 10 g supercapacitor having approximately 6 kW/kg power density, such as the 10DCN2R7Q supercapacitor manufactured by Illinois Capacitor of Lincolnwood, Ill., might store enough power to allow a typical remote control to perform numerous TV commands (e.g., button presses and transmissions, for example, to turn on/off power, raise/lower volume, change channels, etc.) before needing to be recharged.

Power storage device 310 stores received power from recharging manager 312 and provides power, as necessary, to power supply 308. Power supply 308 provides one or more DC operating voltages to various elements of remote control 300. I/O interfaces 304 receive user-input commands from one or more sources, for example, buttons, switches, motion sensors, accelerometers, touchscreens, joysticks, scroll wheels, and the like. Controller 306 processes the user input received from I/O interfaces 304 and, in response to the user input, might send a signal to transmitter 302 to transmit a corresponding command to the master device (e.g., one of TV 102 and devices 110) corresponding to remote control 300. Transmitter 302 might transmit signals via an IR transmitter, such as the TSAL6200 emitter by Vishay Semiconductors of Malvern, Penn., or any other suitable IR transmitter. Alternatively, or additionally, transmitter 302 might transmit signals via an RF transmitter and antenna (not shown). In some embodiments, the RF transmitter might be implemented as an IEEE 802.15 (e.g., “Bluetootht”) transceiver such as the LMX9830 by Texas Instruments/National Semiconductor of Dallas, Tex., or any other suitable RF transmitter or other networked connection.

FIG. 4 shows an exemplary diagram of charging stations 402 and 406 of peripheral device charger 216. As shown in FIG. 4, in some embodiments, peripheral device charger 216 might include one or more docking-type charging stations 402 (referred to herein as docking stations 402) that hold remote device 300 in place and recharge remote device 300 via charging contacts 404. Docking stations 402 might be placed on the rear panel of TV 102 as shown, or might be placed on any area of the structural frame of TV 102 that has sufficient physical space to allow for location of the docking station. Additionally, an inductive-type charging station 406 (referred to herein as inductive charging pad 406) might be placed on the surface of a structural panel of TV 102 near where remote devices might easily be placed.

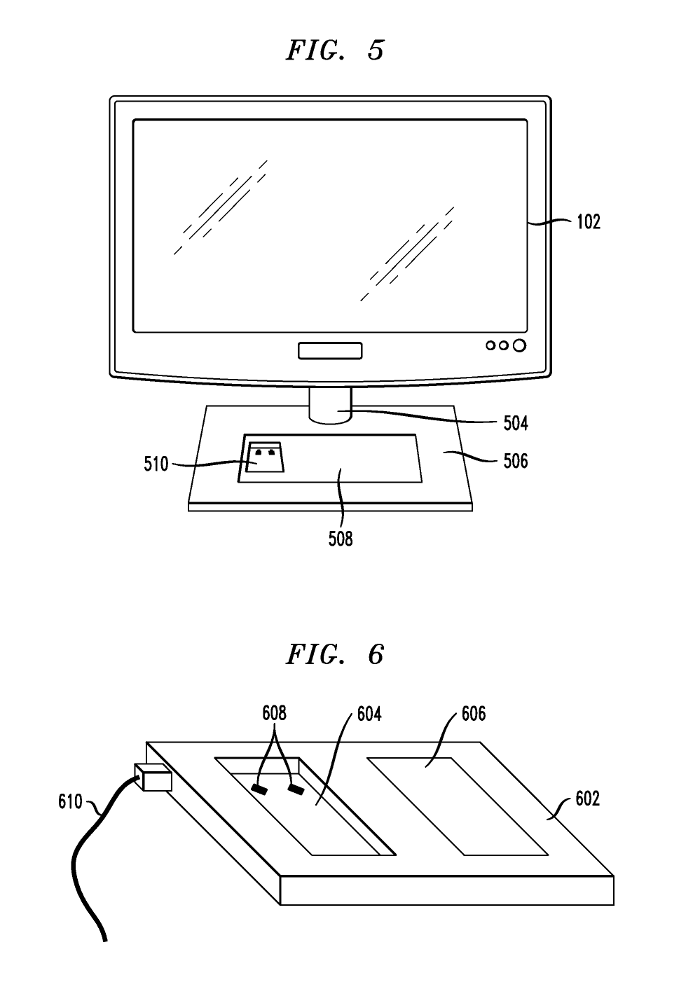

FIG. 5 shows another exemplary diagram of charging stations 508 and 510 of peripheral device charger 216. As shown in FIG. 5, in some embodiments, peripheral device charger 216 might include one or more docking stations 510 and/or one or more inductive charging pads 508 disposed in a flat portion of base 506 of TV stand 504. Thus, one or more remote devices 300 might be placed in docking stations 510 or placed on inductive charging pads 508 for recharging.

FIG. 6 shows an exemplary diagram of charging unit 602. Charging unit 602 might be located remotely from TV 102 and home theater devices 110. As shown in FIG. 6, in some embodiments, charging unit 602 might include one or more docking stations 604 with charging contact sets 608 and/or one or more inductive charging pads 606. Thus, one or more remote devices 300 might be placed in docking stations 604 or placed on inductive charging pads 606 to be recharged without being placed in close proximity to TV 102. Charging unit 602 receives power from the electric mains via cord 610. In some embodiments, cord 610 might be implemented as a power adapter.

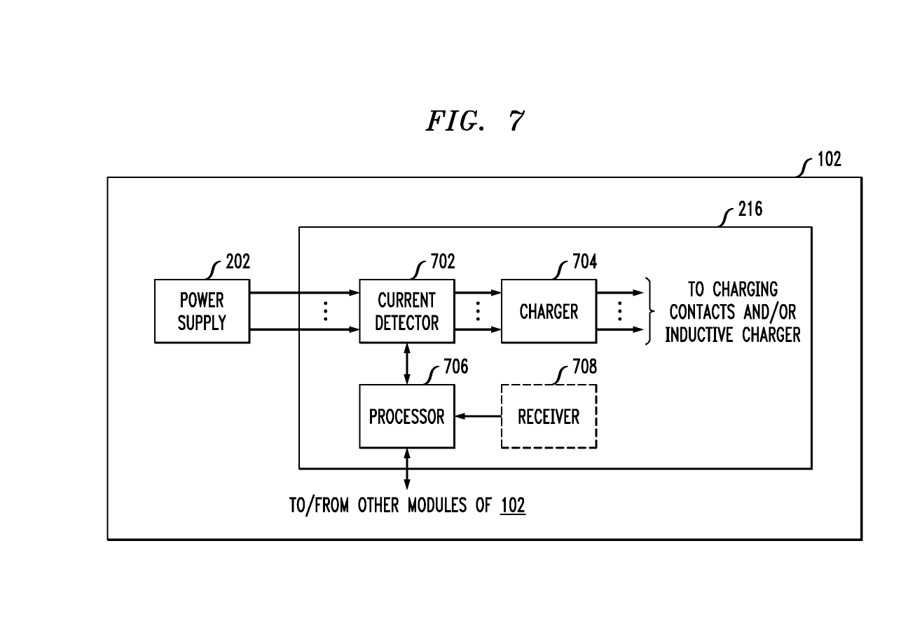

FIG. 7 shows an exemplary block diagram of the circuitry of peripheral device charger 216. As shown, peripheral device charger 216 receives one or more voltages from power supply 202 of TV 102. Each voltage is provided to current detector 702, which detects current flow on each voltage between power supply 202 to charger 704. Charger 704 provides suitable voltage and current to the various charging stations (e.g., 402, 406, 508 and 510) to recharge the batteries or supercapacitors of the various remote devices 300. Peripheral device charger 216 includes processor 706 that is in communication with current detector 702, receiver 704 and various of the other power consuming modules of TV 102 as shown in FIG. 2. As indicated by the dashed line, peripheral device charger 216 might optionally include receiver 708 that might receive wireless communications (e.g., IR or RF) from the various remote devices 300.

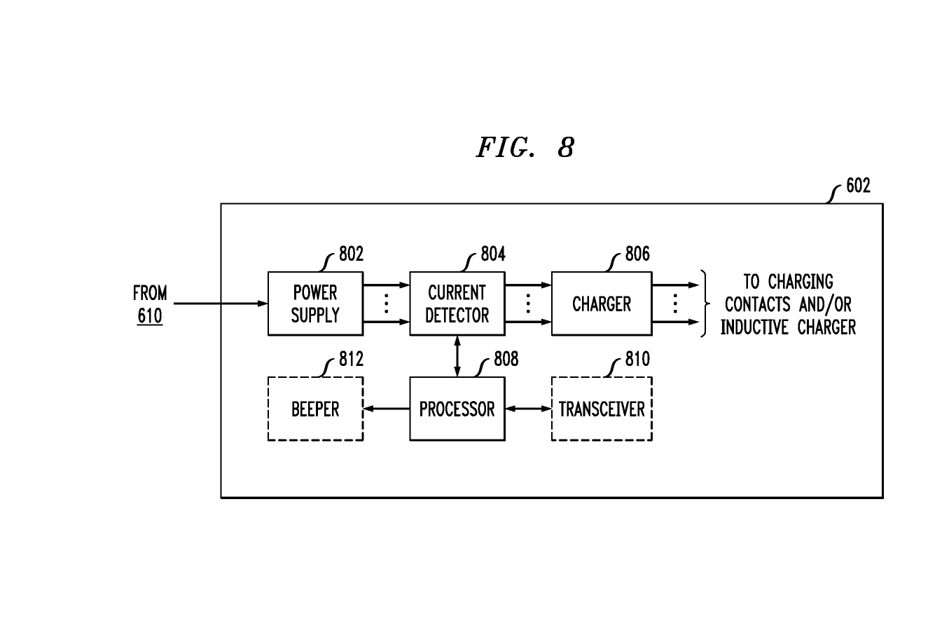

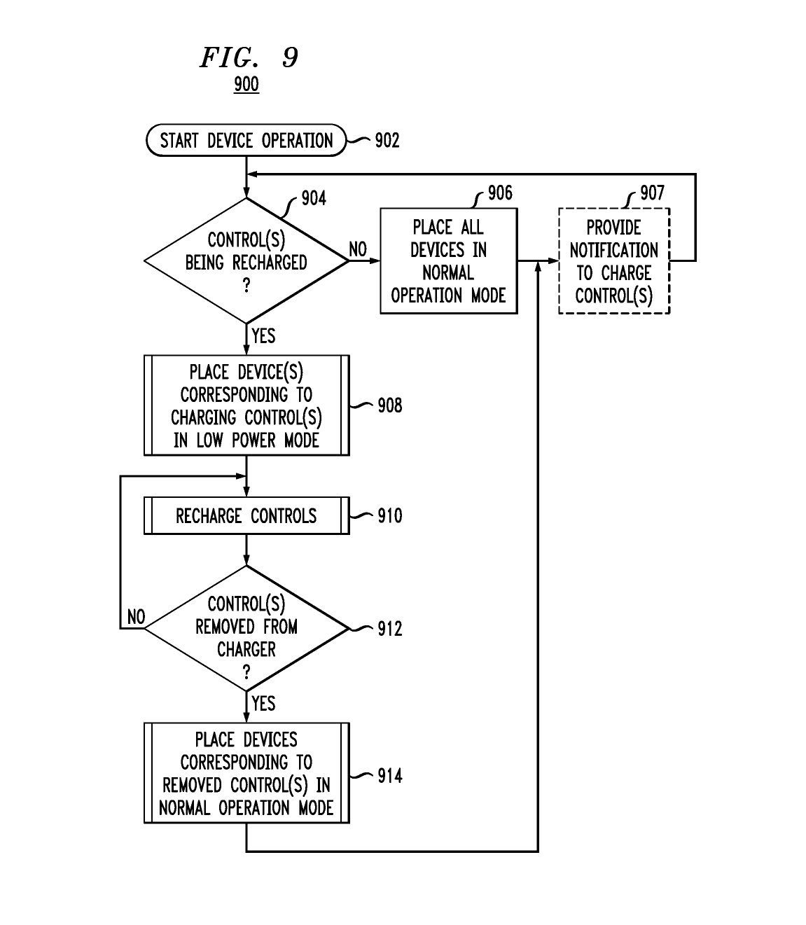

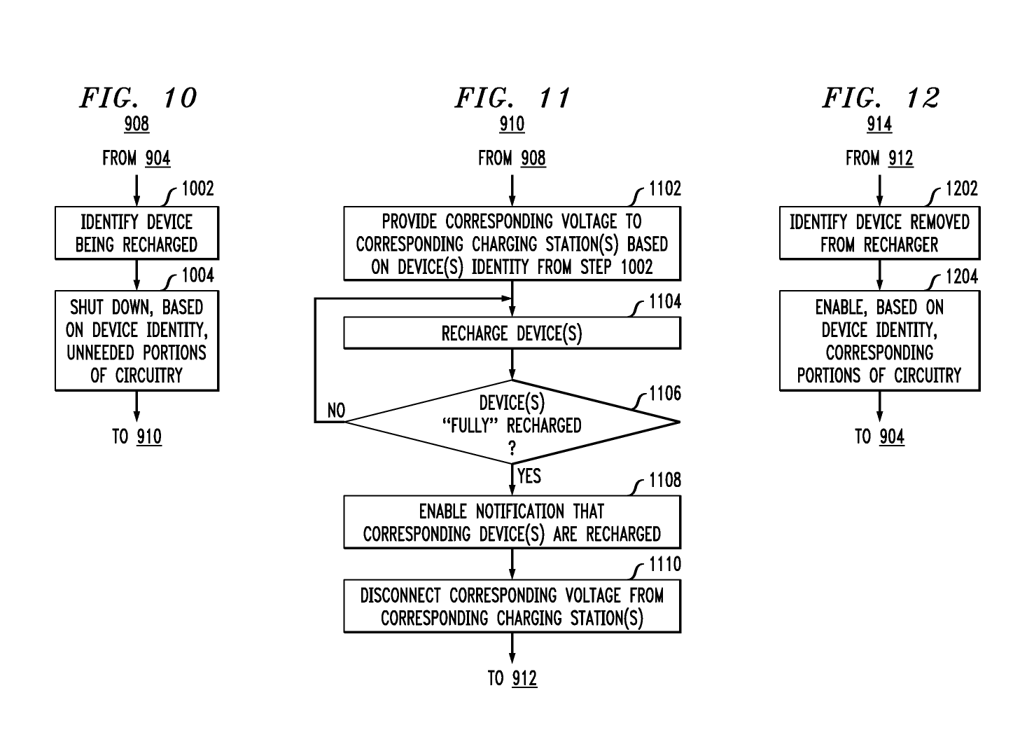

In some embodiments, peripheral device charger 216 might employ one or both of current detector 702 and receiver 708 to determine whether a remote device 300 is being recharged by peripheral device charger 216, and/or to identify which remote device is being recharged. Current detector 702 might be implemented, for example, by measuring a voltage across a resistor of each voltage line by employing a very low resistance resistor and an operational amplifier and/or analog-to-digital converter, by employing an optical phototransistor, by employing a current sensing integrated circuit (IC) or by employing any other suitable current sensing mechanism, such as a Rogowski coil. The current sensing and charging identification functions are described in greater detail in regard to FIGS. 9 through 12. Further, one or both of current detector 702 and receiver 708 might be employed to determine when a given one of remote devices 300 being recharged has been “fully” recharged above a determined charging threshold. In some embodiments, current detector 702 might also be employed to disconnect power supply 202 from charger 704, or to select which voltages from power supply 202 are provided to which charging stations (e.g., 402, 406, 508 and 510). The current control functionality is described in greater detail in regard to FIG. 11.

Although shown herein as being associated with TV 102 (e.g., in FIGS. 2, 4, 5 and 7), peripheral device charger 216 and the corresponding charging stations (e.g., 404 and 406 of FIGS. 4, or 508 and 510 of FIG. 5) might be incorporated into any of home theater devices 110, such as in a top or side surface of a video game console, DVD player, receiver or the like.

FIG. 8 shows an exemplary circuit block diagram of remote charging device 602 of FIG. 6. As shown in FIG. 8, remote charging device 602 might be substantially similar to peripheral device charger 216 shown in FIG. 7. As shown in FIG. 8, remote charging device 602 receives power from the electric mains via cord/adapter 610 and power supply 802 generates one or more voltages provided to current detector 804. Current detector 804 detects current flow on each voltage between power supply 802 and charger 806. Charger 806 provides suitable voltage and current to the various charging stations (e.g., 604 and 606) to recharge the batteries or supercapacitors of the various remote devices 300. Remote charging device 602 includes processor 808 which is in communication with current detector 804 and optional (as indicated by the dashed lines) transceiver 810 and beeper 812.

Transceiver 810 might receive wireless communications (e.g., IR or RF) from the various remote devices 300, and might also transmit wireless communications (e.g., IR or RF) to the various master devices (e.g., one or more of TV 102 and devices 110). In some embodiments, transceiver 810 might be employed to determine the identity of devices being charged by remote charging device 602 (e.g., by receiving transmitted data from the device being recharged). Also, in some embodiments, transceiver 810 might be employed to have one or more corresponding master devices (e.g., one or more of TV 102 and devices 110) enter a low power mode, or notify a user of the recharging status of a remote device 300 (e.g., by transmitting data from remote charging device 602 to the corresponding ones of TV 102 and devices 110). The charging identification and recharging status notification functions are described in greater detail in regard to FIGS. 9 through 12.

In some embodiments, remote charging device 602 might employ one or both of current detector 804 and transceiver 810 to determine whether a remote device 300 is currently recharged by remote charging device 602, and/or to identify which remote device is being recharged. Current detector 804 might be implemented, for example, by measuring a voltage across a resistance of each voltage line, by employing an optical phototransistor, by employing a current sensing integrated circuit (IC) or by employing any other suitable current sensing mechanism, such as a Rogowski coil. The current sensing and charging identification functions are described in greater detail in regard to FIGS. 9 and 10. Further, one or both of current detector 804 and transceiver 810 might be employed to determine when a given one of remote devices 300 being recharged has been “fully” recharged above a determined charging threshold. In some embodiments, current detector 804 might also be employed to disconnect power supply 802 from charger 806, or to select which voltages from power supply 802 are provided to which charging stations (e.g., 604 and 606). The current control functionality is described in greater detail in regard to FIG. 11.

As shown in FIG. 8, remote charging unit 602 (or television 102) might optionally include beeper 812. Beeper 812 might be implemented as a piezoelectric buzzer, a speaker, or any other suitable device for generating an audible indication. For example, beeper 812 might provide an audible indication, such as a beep, buzz, voice synthesis, or any other audible indication, and might optionally included corresponding visual cues displayed on television 102. Processor 808 might also control one or more LED indicators (not shown) in conjunction with beeper 812. Beeper 812 and one or more visual indicators, such as LEDs or menu prompts displayed on TV 102, might be employed to notify a user of the charging status of the various remote devices 300. This notification is described in greater detail in regard to FIG. 11.

FIG. 9 shows an exemplary flow diagram of operation process 900 of a peripheral device recharger (e.g., 216, 602) in accordance with described embodiments. As shown in FIG. 9, operation of one or more master devices (e.g., TV 102 and devices 110) begins at step 902, for example at an initial power up of the master devices. At step 904, the peripheral device recharger determines whether one or more remote control devices 300 are recharging. If, at step 904, at least one remote control device 300 is recharging, then process 900 continues to step 908. If, at step 904, no remote control devices 300 are recharging, then process 900 continues to step 906, where the master devices are placed in a normal operation mode. The normal operation mode allows the master devices to be operated in “on” or “off” modes, where all modules of the master devices are fully powered according to the normal operation of the “on” and “off” modes. Alternatively, if, at step 904, no remote controls are recharging, but the corresponding master device is “off”, the master control might similarly be placed in a low-power mode similarly if all types of remote control devices are recharging. After the master devices are placed in a normal operation mode, at optional step 907 (as indicated by the dashed lines), some embodiments might provide a notification or reminder to a user to recharge one or more corresponding remote controls once the user turns off a given master device. For example, the reminder might be an audible notification (e.g., by beeper 812 or speakers 204) that does not silence until a corresponding remote is placed on a charger (or other action is taken by the user to ignore the notification. In some embodiments, a visual indicator, such as an LED, might be activated, either on the remote device itself, on the charging station, or on the corresponding master device, to indicate a reminder to recharge a remote device. In other embodiments, a signal might be transmitted to TV 102 to display a menu message, indicating which of remote devices 300 should be recharged. After step 907, process 900 returns to step 904.

At step 908, when one or more remote control devices 300 are recharging, the master device(s) corresponding to the remote control(s) on the charger are transitioned from the normal operation mode to a low power mode. In low power mode, one or more components or sub-modules (e.g., as shown in FIG. 2) of the master devices (e.g., TV 102 and devices 110) corresponding to the recharging remote controls might be turned off, operated at a reduced rate, or otherwise have their operation adjusted, thus reducing power consumption of the master device(s), since, while the remote control device is being recharged, various components of the master device might not be in use. Additional details of step 908 are shown in FIG. 10, described subsequently. At step 910, the remote control devices are recharged by the peripheral device recharger. Additional details of step 910 are shown in FIG. 11, described subsequently. At step 912, if at least one recharging device is removed from the charger, at step 914, the master device(s) corresponding to the remote control(s) removed from the charger are transitioned from the low power mode to the normal operation mode. Additional details of step 914 are shown in FIG. 12, described subsequently. At step 912, if no remote control devices are removed from the charger, the devices continue to be recharged at step 910.

FIG. 10 shows additional detail of step 908 of FIG. 9. As shown in FIG. 10, at step 1002, the peripheral device recharger identifies each device that is recharging. In some embodiments, upon being recharged, the remote control device transmits (e.g., via transmitter 302) a wireless signal (e.g., IR or RF) to the peripheral device recharger indicating an ID of the device that is being recharged. The signal is received by the peripheral device recharger (e.g., by receiver 708 or transceiver 810). In other embodiments, upon being recharged, the remote control device transmits via a signal over physical contacts of the charger, or by a backchannel of the charger, a signal to the peripheral device recharger indicating the ID of the device that is being recharged. The signal is received by the peripheral device recharger (e.g., by processors 706 or 808).

At step 1004, for peripheral device recharger 216, based on the ID of the device being recharged, processor 706 identifies any corresponding modules of TV 102 that can be disabled or removed from power in low power operation mode. Once the modules are identified, processor 706 sends a signal from processor 706 to the various corresponding modules to disable corresponding modules, open switches to remove power from various modules and enter low power mode. Similarly, at step 1004, for remote charging device 602, based on the ID of the device being recharged, processor 808 identifies any corresponding modules of the one or more master devices corresponding to the recharging remote that can be disabled or removed from power in low power operation mode. Once the modules are identified, processor 808 sends a signal to transceiver 810 to send a signal to each corresponding master device (e.g., at least one of TV 102 and devices 110) to disable the various corresponding modules, open switches to remove power from various corresponding modules and enter low power mode. In some embodiments, processor 808 might instead provide the signal to the recharging remote, and employ transmitter 302 of the recharging remote to send the signal to the corresponding master devices. After step 1004, processing continues to step 910.

As described herein, the one or more modules of TV 102 or other devices 110 that might be placed in a low power or no power mode are identified based on the ID of the remote device 300 being recharged. For example, if 3D glasses 104 are being recharged, it might be possible to reduce power consumption of AN processing module 212 by disabling 3D video processing. Similarly, if remote controls 106 or 108 corresponding to a given one of TV 102 or devices 110 is being recharged, it might be more likely that the corresponding one of TV 102 or devices 110 is not in use. Thus, various modules within the corresponding one of TV 102 or devices 110 could be entirely disabled or unpowered since they are not in use.

FIG. 11 shows additional detail of step 910 of FIG. 9. As shown in FIG. 11, at step 1102, upon receiving the ID of the device being recharged (e.g., from step 1002 of FIG. 10) the processors (e.g., 706 or 808) might configure the current detector (e.g., 702 or 804) or power supply (e.g., 202 or 802) to provide the appropriate recharging voltage for the identified recharging remote device 300 to the corresponding charging station. At step 1104, the remote device 300 is recharged, for example via contacts (e.g., 404, 510 or 608) or inductive charging pads (e.g., 406, 508 or 606). At step 1106, the peripheral device recharger determines whether the remote device 300 is recharged above a threshold (e.g., is “fully” recharged). For example, in some embodiments, remote device 300 might transmit a signal indicating a percentage charge of power storage device 310. If, at step 1106, the remote device 300 is not “fully” recharged, the device continues being recharged at step 1104. If, at step 1106, the remote device 300 is “fully” recharged, at step 1108, one or more notifications that remote device 300 is “fully” recharged might be activated. For example, in some embodiments, processor 808 might activate beeper 812 to beep, indicating a “fully” charged remote device. In some embodiments, a visual indicator, such as an LED, might be activated, either on the remote device itself, or on the charging station, to indicate a “fully” charged remote device. In yet other embodiments, the peripheral device recharger might transmit a signal to TV 102 to display a menu message, for example when TV 102 is next powered on, indicating which of remote devices 300 are fully recharged. In alternative embodiments, beeper 812 (or speakers 204) might be triggered to sound an audible alert if a remote control is not recharged when TV 102 is turned off. At step 1110, the processors (e.g., 706 or 808) might configure the current detector (e.g., 702 or 804) or power supply (e.g., 202 or 802) to remove the recharging voltage for the identified recharging remote device 300 from the corresponding charging station. After step 1110, processing continues to step 912.

FIG. 12 shows additional detail of step 914 of FIG. 9. As shown in FIG. 12, at step 1202, the peripheral device recharger identifies each device removed from the recharger. In some embodiments, upon being removed from the recharger, the remote control device transmits (e.g., via transmitter 302) a wireless signal (e.g., IR or RF) to the peripheral device recharger indicating an ID of the device that has been removed from the recharger. The signal is received by the peripheral device recharger (e.g., by receiver 708 or transceiver 810). In other embodiments, upon being recharged, the peripheral device recharger might determine which charging station is no longer drawing current (e.g., by current detectors 702 or 804) to determine which device was removed from the recharger. The signal is received by the peripheral device recharger (e.g., by processors 706 or 808).

At step 1204, for peripheral device recharger 216, based on the ID of the device removed from the recharger, processor 706 identifies any corresponding modules of TV 102 that can be transitioned from low power operation mode to normal operation mode (e.g., corresponding modules are re-enabled or have switches set to restore power). Once the modules are identified, the peripheral device recharger (e.g., by processors 706 or 808) sends a signal from to the various corresponding modules to enable corresponding modules, close switches to provide power to various modules and transition from low power mode to normal operation mode. After step 1204, processing continues to step 904.

Thus, as described herein, in described embodiments provide a local electronic device having a power supply coupled to a power main in wireless communication, via a wireless transceiver, to a remote peripheral device. The local electronic device includes a charging station to recharge a rechargeable power supply of the remote peripheral devices. The local electronic device detects when at least one remote peripheral device is being recharged by the charging station. Based on the detection, the local electronic device selectively enters a low-power mode by disabling one or more circuits to reduce power consumption.

While the exemplary embodiments of the present invention have been described with respect to processing blocks in a software program, including possible implementation as a digital signal processor, micro-controller, or general-purpose computer, the present invention is not so limited. As would be apparent to one skilled in the art, various functions of software might also be implemented as processes of circuits. Such circuits might be employed in, for example, a single integrated circuit, a multi-chip module, a single card, or a multi-card circuit pack.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

It will be further understood that various changes in the details, materials, and arrangements of the parts that have been described and illustrated in order to explain the nature of this invention might be made by those skilled in the art without departing from the scope of the invention as expressed in the following claims.

We claim:

1. An apparatus comprising:
a local electronic device comprising a power supply coupled to a power main;
a wireless transceiver configured to provide wireless communication for the local electronic device;
a charging station configured to recharge a rechargeable power supply of one or more of remote devices, each remote device configured to provide commands to the local electronic device through the wireless transceiver;
wherein, the local electronic device is configured to detect recharging of at least one remote device by the charging station, and, based on the detection, the local electronic device is configured to selectively enter a low-power mode,
wherein, in the low-power mode, the local electronic device is configured to selectively adjust operation of or disable one or more circuits within the local electronic device, thereby reducing power consumption by the local electronic device.

2. The apparatus of claim 1, wherein the charging station is configured to detect recharging of at least one remote device by at least one of: detecting a current flow of the charging station and receiving a signal from a remote device that is being recharged.

3. The apparatus of claim 2, wherein, if the local electronic device is off, and no remote device is being charged, the local electronic device is further configured to:
enable a warning signal indicating that no remote devices are being recharged.

4. The apparatus of claim 2, wherein, the charging station is further configured to:
determine whether charge of the remote device reached a threshold, and, if so:
enable a notification signal indicating that the corresponding remote device is recharged; and
selectively remove recharging power from the remote device.

5. The apparatus of claim 4, wherein the notification signal comprises at least one of:
a visible indication on the remote device, a visible indication on the charging station corresponding to the recharged remote device, an audible indication, and a menu screen displayed on a screen of the local electronic device indicating that the remote device is recharged.

6. The apparatus of claim 2, wherein each remote device is configured to, when recharging by the charging station, transmit a signal to at least one of the charging station and the local electronic device, the signal identifying the remote device.

7. The apparatus of claim 6, wherein the local electronic device is configured to selectively adjust operation of or disable circuits in the low-power mode based on the identified one or more remote devices recharging.

8. The apparatus of claim 6, wherein the local electronic device is configured to, based on the identified remote device, provide an appropriate recharging voltage to the corresponding charging station, the appropriate recharging voltage corresponding to the identified remote device.

9. The apparatus of claim 1, wherein the charging station is integral to a body component of the local electronic device.

10. The apparatus of claim 9, wherein:
the charging station is an inductive charging pad configured to wirelessly provide power to recharge one or more remote devices;
the inductive charging pad is integral with at least one of: a panel of the local electronic device and a panel of a stand configured to support the local electronic device; and
the one or more remote devices are configured to recharge through inductive energy transfer from the corresponding inductive charging pad.

11. The apparatus of claim 10, wherein the local electronic device is a television, and the inductive charging pad is integrated into a stand configured to hold the television.

12. The apparatus of claim 9, wherein:
the charging station is a docking station configured to hold one or more remote devices, the docking station having contacts configured to provide power to recharge one or more remote devices;
the docking station is integral with at least one of: the local electronic device and a stand configured to support the local electronic device; and
the one or more remote devices each have contacts configured to align with the contacts of the charging station, wherein the one or more remote devices are configured to be recharged by direct energy transfer from the contacts.

13. The apparatus of claim 1, wherein:
the remote device is at least one of: a remote control, a game controller, a keyboard, a mouse, and three-dimensional (3D) viewing glasses; and
the local electronic device is at least one of: a television, a stereo receiver, a cable television receiver, a satellite receiver, a video game console, a personal computer, a video recorder, and a DVD player.

14. The apparatus of claim 1, wherein the charging station is a remote charging station in communication with the local electronic device by a wireless link.

15. The apparatus of claim 14, wherein the remote charging station is at least one of an inductive charging pad, a power adapter, and a docking station.

16. The apparatus of claim 15, wherein the wireless link is at least one of: an infrared link and a radio frequency link.

17. The apparatus of claim 16, wherein the wireless link is provided by at least one of a transceiver device of the remote charging station and a transmitting device of the remote device.

18. The apparatus of claim 1, wherein the rechargeable power supply of each remote device comprises at least one of: a supercapacitor and a rechargeable battery.

19. The apparatus of claim 1, wherein each remote device is configured to control more than one local electronic device.

20. A method of operating at least one local electronic device, the local electronic device comprising a power supply coupled to a power main and a wireless transceiver in wireless communication with one or more remote devices, each remote device comprising a rechargeable power supply, the method comprising:
detecting, by the local electronic device, recharging of at least one remote device by a charging station associated with the local electronic device; and,
based on the detection, selectively entering, by the local electronic device, a low-power mode, wherein, in the low-power mode, the local electronic device selectively adjusts operation of, or disables, one or more circuits of the local electronic device, thereby reducing power consumption of the local electronic device.

21. The method of claim 20, wherein the detecting step comprises at least one of:
detecting a current flow of the charging station; and
receiving a signal from a recharging remote device.

22. The method of claim 20, wherein, if the local electronic device is turned off, and no remote device is recharging, the method further comprises:
enabling, by the local electronic device, a warning signal indicating that no remote devices are recharging.

23. The method of claim 20, comprising:
transmitting, by each remote device recharging by the charging station, a signal to at least one of the charging station and the local electronic device, the signal identifying the remote device; and
identifying, by the local electronic device based on the identified one or more recharging remote devices, which circuits to adjust operation of, or disable, in the low-power mode.

24. The method of claim 20, wherein for the method:
the charging station is integral to a body component of the local electronic device;
the charging station is at least one of: (i) an inductive charging pad configured to wirelessly provide power to recharge one or more remote devices, and (ii) a docking station configured to hold one or more remote devices, the docking station having contacts configured to provide power to recharge one or more remote devices;
the method further comprising:
if the charging station is an inductive charging pad:
recharging the one or more remote devices by inductive energy transfer from the inductive charging pad; and
if the charging station is a docking station:
recharging the one or more remote devices by direct energy transfer from the contacts.

25. The method of claim 20, wherein, for the method:
the remote device is at least one of: a remote control, a game controller, a keyboard, a mouse, and three-dimensional (3D) viewing glasses; and
the local electronic device is at least one of: a television, a stereo receiver, a cable television receiver, a satellite receiver, a video game console, a personal computer, a video recorder, and a DVD player.

26. The method of claim 20, wherein the charging station is a remote charging station in communication with the local electronic device by a wireless link, the method further comprising:
detecting, by the remote charging station, when at least one remote device is recharging; and
communicating, to the local electronic device by the remote charging station over the wireless link, a request to enter a low-power mode, wherein, in the low-power mode, the local electronic device adjusts operation of, or disables, one or more circuits of the local electronic device, thereby reducing power consumption, wherein the remote charging station is at least one of an inductive charging pad, a power adapter, and a docking station.

27. The method of claim 26, comprising:
providing the wireless link by at least one of a transceiver device of the remote charging station and a transmitting device of the remote device.

28. The method of claim 20, wherein, for the method, the remote device comprises at least one of: one or more supercapacitors and one or more rechargeable batteries.

29. The method of claim 21, further comprising:
determining whether a charge of the remote device has reached a threshold, and, if so:
enabling a notification signal indicating that the corresponding remote device is recharged; and
removing recharging power from the remote device,
wherein the notification signal comprises at least one of: a visible indication on the remote device, a visible indication on the charging station corresponding to the recharged remote device, an audible indication, and a menu screen displayed on a screen of the local electronic device indicating that the remote device is recharged.

30. The method of claim 23, further comprising, based on the identified remote device:
providing an appropriate recharging voltage to the corresponding charging station, the appropriate recharging voltage corresponding to the identified remote device.

31. The method of claim 20, wherein the method is implemented by a machine executing program code encoded on a non-transitory machine-readable storage medium.
